(19) United States
(12) Patent Application Publication
(10) Pub. No.: US 2017/0316845 A1
(43) Pub. Date: Nov. 2, 2017

(54) FLEXIBLE IRRADIATION FACILITY

(71) Applicant: Technische Universiteit Delft, Delft (NL)

(72) Inventors: Peter Bode, Delft (NL); Antonia Georgieva Denkova, Delft (NL); Hurbert Theodoor Wolterbeek, Delft (NL); Rene Martin Gommers, Delft (NL); Baukje Elisabeth Terpstra, Delft (NL)

(21) Appl. No.: 15/605,711

(22) Filed: May 25, 2017

Related U.S. Application Data
(63) Continuation of application No. PCT/NL2015/050822, filed on Nov. 25, 2015.

(30) Foreign Application Priority Data
Nov. 25, 2014 (NL) 2013872

(51) Int. Cl. G21G 1/06; G21C 23/00; G21G 1/02; H05H 6/00

(52) U.S. Cl. CPC G21G 1/06; H05H 6/00; G21C 23/00; G21G 1/02

(57) ABSTRACT

An irradiation facility for a nuclear reactor, a method of removing thermal heat from an irradiated object and adjusting an energy distribution/neutron/gamma-ray flux ratio of irradiation, and a product obtainable by the method.

### CROSS-REFERENCE TO RELATED APPLICATIONS

This application is a continuation of Patent Cooperation Treaty Application No. PCT/NL2015/050822, entitled “Flexible Irradiation Facility”, to Technische Universiteit Delft, filed on Nov. 25, 2015, which claims priority to Netherlands Patent Application Serial No. 2013872, filed Nov. 25, 2014, and the specifications and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COM-PACT DISC

Not Applicable.

### COPYRIGHTED MATERIAL

Not Applicable.

### FIELD OF THE INVENTION (TECHNICAL FIELD)

The present invention is in the field of irradiation of objects with nuclear reactor radiation.

A nuclear reactor is a device to initiate and control a sustained nuclear chain reaction. Nuclear reactors can be used as a nuclear power plant for generating electricity and likewise for propulsion of e.g. ships. Some reactors are used to produce isotopes for medical and industrial use, as is the present case, or for production of e.g. plutonium for nuclear weapons. Some reactors are run only for research.

The present reactor relates to a nuclear fission reactor. Therein a uranium nucleus splits into two or more lighter nuclei, thereby releasing kinetic energy, and of particular interest in view of the present application gamma radiation, and free neutrons. The nuclear chain reaction is caused by a portion of these free neutrons which may after release be absorbed by other fissile nuclei and thus trigger further fission events. To control a nuclear chain reaction, neutron poisons and neutron moderators are present in order to change a portion of neutrons that causes further fission. Examples of such moderators include regular (light) and heavy water, and solid graphite.

The irradiation is used to generate isotopes, and specifically radionuclides. Isotopes are variants of a (given) particular chemical element: all isotopes of a given element have the same number of protons in their atom in common, and they differ in their neutron number. A radionuclide is an atom with an unstable nucleus, which is a nucleus characterized by excess energy available to be imparted either to a newly created radiation particle within the nucleus or to an atomic electron. The radionuclide, in this process, undergoes radioactive decay, and emits one or more of the following; photons, electrons, positrons, or alpha particles, directly or indirectly. These particles constitute ionizing radiation. Radionuclides occur also naturally, and can also be artificially produced, such as in a nuclear reactor.

The number of nuclei of radionuclides is uncertain. Some nuclides are stable and some decay. The decay is characterized by a half-life. Including artificially produced nuclides, more than 3300 nuclides are known (including ˜3000 radionuclides), including many more (>˜2400) that have decay half-lives shorter than 60 minutes. This list expands as new radionuclides with very short half-lives are identified.

Radionuclides are often referred to by chemists and physicists as radioactive isotopes or radioisotopes. Radioisotopes with suitable half-lives play an important part in a number of constructive technologies (for example, nuclear medicine).

According to current practice, objects are exposed to radiation produced in a nuclear reactor so as to evoke nuclear reactions. The neutron energy is considered a depending parameter in the type and effectiveness of the nuclear reaction. A (continuous) energy distribution of the neutrons is found to result in simultaneous/parallel nuclear reactions of the same or other isotopes of the element with neutrons of different energies. The intended nuclear reaction can thus be interfered by other reactions, limiting the intended use.

The energy distribution of the neutron radiation in facilities at light water moderated reactors can be changed by covering the objects themselves with a shielding material containing high amounts of cadmium or boron, thereby absorbing almost completely the fraction of neutrons with energies below 1 eV (thermal neutron fraction) leaving epithermal and fast neutrons. This approach, often denoted as ‘epithermal neutron activation’ is applied if the desired nuclear reaction occurs with neutrons of energy higher than 1 eV and the interfering nuclear reaction occurs mostly with thermal neutrons. Use of cadmium and boron containing shielding is not applied in heavy water moderated reactors given the very low fraction of epithermal and fast neutrons remaining after shielding.

Except for neutrons, typically also high energy beta-radiation and gamma-radiation are produced in a nuclear reactor, as well as so-called delayed (gamma) rays. High energy gamma-rays can be used for nuclear reactions of the (gamma,n) type, resulting in neutron-deficient nuclei. Uncontrolled production of radiation is a serious concern for irradiating objects, e.g. as radiation may destroy such objects. It is noted that once an object or an facility for irradiation has entered a reactor access thereto is very limited or even prohibited.

A use of so-called resonance window filters of neutrons is described, which relates to well-defined conditions in an approach that has only been applied so far inside a neutron beam for neutron physics measurements.

In view of target cooling typically liquid nitrogen is used. Such is for many applications impractical.

Some recent developments are discussed below.

In U.S. Pat. No. 3,955,093 A, a target for preparation of radioisotopes by nuclear bombardment, and a method for its assembly are provided. A metallic sample to be bombarded is enclosed within a metallic support structure and the resulting target subjected to heat and pressure to effect diffusion bonds there between. The bonded target is capable of withstanding prolonged exposure to nuclear bombardment without thermal damage to the sample.

US 2006/0126774 A1 recites an internal circulating irradiation capsule available for the production of iodine-125 and a related production method. The irradiation capsule filled with xenon gas has a lower irradiation part, an upper irradiation part, and a neutron control member. The lower irradiation part is inserted into an irradiation hole of a reactor core and irradiated with a large quantity of neutron directly. When neutron is radiated to the xenon gas, iodine 125 is produced from xenon gas. The upper irradiation part protrudes from the irradiation hole, and iodine-125 is transferred to the upper irradiation part by convection and solidified in the upper part. The neutron control member reduces neutron in the upper part to produce iodine-125 of high purity and radioactivity in a large quantity.

US 2013/0315361 A1 recites apparatuses and methods produce radioisotopes in multiple instrumentation tubes of operating commercial nuclear reactors. Irradiation targets may be inserted and removed from multiple instrumentation tubes during operation and converted to radioisotopes otherwise unavailable during operation of commercial nuclear reactors. Example apparatuses may continuously insert, remove, and store irradiation targets to be converted to useable radioisotopes or other desired materials at several different origin and termination points accessible outside an access barrier such as a containment building, drywell wall, or other access restriction preventing access to instrumentation tubes during operation of the nuclear plant. Example systems can simultaneously maintain irradiation targets in multiple instrumentation tubes for desired irradiation followed by harvesting.

The above documents do not recite specific measures for adjusting an energy distribution for specific species.

The present invention therefore relates to an improved irradiation facility for a nuclear reactor, to a method of removing thermal heat from an irradiated object and adjusting an energy distribution/neutron/gamma-ray flux ratio of irradiation, and to a product obtainable by said method, which solve one or more of the above problems and drawbacks of the prior art, providing reliable results, without jeopardizing functionality and advantages.

### BRIEF SUMMARY OF THE INVENTION

The present invention relates to an improved irradiation facility for a nuclear reactor, to a method of removing thermal heat from an irradiated object and adjusting an energy distribution/neutron/gamma-ray flux ratio of irradiation, to a use, and to a product obtainable by the method.

The present irradiation facility is moveable towards and from a nuclear reactor and is moveable inside said nuclear reactor. Also parts thereof, such as the sample and the adaptable filter, or parts thereof, can be moved inside the facility as well, of course taking great care in view of radiation. As a consequence dimensions of the facility are limited, such as to 50 by 50 by 50 cm³. The present holder can receive a sample through an opening thereof, and receive the adaptable filter.

The adaptable filter may comprise a “band-gap” filter, may comprise a blocking medium of certain energies, may comprise a gamma radiation generator, and combinations thereof.

In general a band-gap (or band-pass) filter is considered a device that passes frequencies within a certain range and rejects (attenuates) frequencies outside that range. For the present application the bang gap filter allows certain energies (and likewise species) to pass through.

The present inventors have identified that radiation is also found to result in, except for the intended use, radiation damage of the material irradiated, varying from barely measurable material defects to partly or complete decomposition. The extent of radiation damage is found to depend on the material irradiated, the energy distribution of the neutrons and gamma-rays impinging on the object, and the temperature of the object, partly due to thermal excitation resulting from the absorption of neutrons and the prompt nuclear reaction products. As a guidance, organic materials are typically more prone to radiation damage effects than inorganic materials, though decomposition is known to occur also in inorganic compounds containing hydrate water or nitrate ions. As a consequence the present filter may need to be applied.

Radiation damage is found to increase at prolonged irradiation duration. This typically limits the production of radionuclides of high specific activity in materials of organic composition. The present invention reduces radiation damage of (organic)materials used in nuclear medicine radioisotope production with a nuclear reactor. Such is accomplished by reducing the exposure of materials by unwanted (gamma, neutron) radiation of specific energies during irradiation, and further by reducing a temperature increase during irradiation. The invention provides the production of radioisotopes bound to or being part of organic chemical compounds having a substantially higher specific activity by prolonged irradiation duration.

The present invention provides an flexible and movable irradiation facility for use in a (light water moderated) nuclear reactor in which a ratio of an intended nuclear reaction rate and an interfering nuclear reaction rate can be enhanced, and in which the gamma-radiation can be used on demand for nuclear reactions or be maximal reduced, and the thermal heat in the object can be removed.

In the present invention, the enhancement of the ratio of the desired nuclear reaction rate and the interfering nuclear reaction rate may be accomplished by the use of the present filter having modular shielding material each independently of a specific composition. Thereby e.g. the number of neutrons of desired energy range is favourably biased by reducing the number of neutrons causing the interfering reaction. The filter is preferably of a modular nature, each module (or sheet) having specific characteristics in view of filtering radiation and of providing a window for other radiation. Each module or sheet is preferably relatively thin compared to a width and length thereof, such as 0.1 mm-5 cm. Each module may be formed from one or a combined material, such as an alloy. Also parts of the module may be formed from a first material, and other parts from a second material, etc. Typically a module comprises at least one sheet, each sheet comprising a specific material.

The effective use of gamma-radiation for nuclear reactions may be accomplished by producing high energy gamma's through neutron capture in a suitable material, such as nickel, followed by absorption of the remaining thermal neutrons in a strong neutron absorbing material, such as cadmium.

The removal of the thermal heat from the object may be accomplished by a flow of reactor pool water cooled down to e.g. 4° C. using an external heat exchanger.

In the present invention the object to be irradiated may be positioned in an irradiation facility with a rectangular or cylindrical shaped irradiation end. The shape can depend on the design of the reactor and available physical space for positioning the facility. An irradiation end may have openings for positioning the object and for multiple modular sheets of neutron and/or gamma-ray shielding material (an example is shown in FIG. 1). Aluminium alloys may be used for construction and cladding of the shielding materials. The openings may be cylindrical or rectangular.

The facility may be equipped with guides for loading and removal of the shielding sheets, and a transfer tube facilitating the insertion and removal of objects during reactor operation.

A shielding sheet can be positioned in the irradiation end by only itself, or in combination with other shielding sheets. Empty modules, i.e. modules without neutron or gamma-ray absorbing material and filled with a gas such a nitrogen can be used to fill unused sheet positions to prevent reduction of the neutron flux by water which otherwise would fill the gap.

The sheets may be loaded and unloaded from the irradiation end using a guidance rail system. This system connects the irradiation end with a storage rack. The storage rack may be connected to an upper part of the facility for positioning unused shielding sheets. The storage rack may be at such a distance under the pool water surface that the acceptable radiation dose-enhanced by the activation products in the sheets-remains within the limits, set by the reactor facility.

The positioning and mounting of the facility in the pool in the vicinity of the reactor core may depend on the reactor design.

The present invention provides a modular construction that allows for user specific selection of an optimal combination of gamma-ray and neutron energy shields. The invention further provides adequate cooling and ease of loading and unloading. The invention makes it possible to obtain prolonged irradiation times and thereby providing higher (specific) activities of irradiated targets. Despite advantages, some limitations remain, such as the positioning of the facility near the reactor core and the (maximum) size of the objects to be irradiated.

The present invention is further optimized in view of a target shape, for both up-scaling towards larger amounts with preservation of adequate cooling; in view of a shape of the gamma-ray shielding and neutron resonance filters; and in view of target positioning and removal during reactor operation.

Thereby the present invention provides a solution to one or more of the above mentioned problems and drawbacks.

Advantages of the present description are detailed throughout the description.

### DETAILED DESCRIPTION OF THE INVENTION

The present invention relates in a first aspect to a reactor assembly.

The present filter is capable of or has at least one of shielding the sample against at least one specific species of neutrons, shielding the sample against at least one species of beta rays, shielding the sample against at least one species of gamma-rays, having at least one energy band pass filter for neutrons, at least one energy band pass filter for beta rays, at least one energy band pass filter for gamma rays, and generating of a specific species of gamma-radiation.

In an example of the present facility the adaptable filter comprises at least one sheet, wherein the at least one sheets are placed behind one and another. Therewith shielding can be adapted easily, such as by combining various sheets having various, and typically different, properties.

In an example of the present facility each sheet has a thickness, a composition, and an effective thickness. These may be selected independently per sheet, and may be selected in view of a combinatorial effect thereof. The parameters are selected for at least one of absorbing at least one specific species of neutrons, absorbing at least one species of gamma-rays, absorbing at least one species of beta rays, absorbing a pre-determined fraction of said aforementioned specific species, and generating a pre-determined fraction of a specific species of gamma-radiation. To give an example thereof, various filters may allow passage of a certain neutron energy, may block all entering gamma rays, and generate specific gamma rays. Such allows for a large degree of freedom in composing a filter.

In an example of the present facility the filter or at least parts thereof are removable. If remove a part of the filter can be left empty (or open) or can be replaceable by another filter element. So for a given experiment/irradiation a suitable filter can be composed.

In an example of the present facility a band pass energy of the filter is selected from 0-0.5 keV, 0.5-5 keV, 10-30 keV, 100-200 keV, 250-500 keV, and 0.6-5 MeV, and combinations thereof, the combinations then relating to different species. Likewise the filter may be adapted to certain specific species or combination thereof, the species being at least one of beta rays, gamma rays, and neutrons. In an example a certain energy range of neutrons may be passed through, and likewise a certain energy range of gamma rays.

When referring to an energy or energy distribution such is typically qualified by an average, and an energy range.

In an example of the present facility sheet material is selected from Pb, Cd, Ni, Sc, Fe+Cr, Fe+Al+S, and Si+Ti. Pb is found to block significantly all gamma rays, if thick enough. Cd allows passage of <0.5 keV neutrons, Sc allows passage of [0.5 keV; 5 keV] neutrons, Fe+Al+S allows passage of [10 keV; 30 keV] neutrons, Si+Ti allows passage of [0.5 keV; 5 keV] neutrons, and Ni, Fe and Cr allow generation of >8.9 MeV gamma rays.

In an example of the present facility the filter comprises empty modules, wherein empty modules are filled with an inert material, such as a gas, such as nitrogen. As such the empty slots/sheets do not interfere.

In an example the present facility comprises at least one slot for receiving a shield; as such the shield may be removed and entered easily. The facility optionally comprises as facilitating means guides for loading and unloading.

In an example of the present facility an aluminium alloy is used for construction and cladding of at least one shield. The aluminium alloy provides a long durable material for use under the relatively harsh conditions and hardly interferes with irradiation of the sample.

In a second aspect the present invention relates to a method of the present facility according to claim 11. Therein at least one of thermal heat is removed from an irradiated object, an energy distribution is adjusted, a neutron ray intensity is adjusted, and a gamma-ray intensity is adjusted. The method comprises the steps of providing a radiation source for emitting radiation, such as a nuclear reactor, and shielding an irradiated object with a irradiation facility according to any of the preceding claims. It is noted that an irradiation of an object typically generates heat, which may need to be removed (e.g. from an inside) thereof. The energy distribution applied to the object, typically a sample, may have an optimal energy distribution, and likewise composition of species, which may be pre-determined and typically is pre-determined. In view of this optimal distribution the present filter may be used to shield the object accordingly. The object is typically introduced into the present facility.

In an example of the present method at least one of thermal neutrons are absorbed, neutrons with a specific energy distribution are absorbed, gamma rays with a specific energy distribution are absorbed, beta rays with a specific energy distribution are absorbed, and gamma-rays with a specific energy distribution are created, such as having an energy >8.9 MeV.

In an example of the present method excess heat is in the object is removed by an external means, such as a cooling loop, such as a water cooler. Despite removing unwanted species, e.g. in terms of energy distribution, still some heat may be generated in the object. The excess heat may be removed, thereby reducing damage, improving yield, etc.

In a third aspect the present invention relates to a use according to claim 14, for manipulating an energy distribution of radiation species, such as neutrons, or gamma-rays.

In an example the present use is for absorbing neutrons with an energy of less than 5 eV, such as less than 1 eV. A similar use is envisaged for β-rays and γ-rays, albeit with different energy levels.

In an example the present use is for generating high energy gamma-radiation, such as having an energy of >8.9 MeV. The present use may also be for generating low energy gamma-radiation, such as having an energy of <1.2 MeV.

In a fourth aspect the present invention relates to a product obtained by the present method. The product may be used in medicine, in (radio-) therapy, in (radio-) diagnosis, in cancer therapy, in biology, such as for irradiation of cells, in chemistry, and in material science.

In an example the present product is selected from ¹⁶⁶Ho-isotope comprising organic molecules (such as organic polymers, such as poly lactic acid), ⁹⁹Mo-isotope comprising organic molecules, ^{177+177m}Lu in an organometallic molecule. These products can easily be identified.

In an example the present product has a specific activity of more than 100 GBq/g isotope, preferably more than 125 GBq/g isotope, more preferably more than 150 GBq/g isotope, even more preferably more than 200 GBq/g isotope, such as more than 250 GBq/g isotope. Such a product distinguishes itself over the prior art in the specific activity, which activity is relatively easy to determine.

The present product may be used for diagnosis, therapy, generation of radiation, subtle treatment, imaging, generating soft beta's, for liver related purposes, etc. In said products radiation damage and/or radiological decomposition and/or thermal decomposition of the product is at least reduced by a factor 5-10 compared to prior art techniques, as a consequence of use of the present facility.

It is noted that the term “substantial” is intended to indicate that within a given accuracy, such as measurement, manufacturing, etc. elements are e.g. in line, etc.

The one or more of the above examples and embodiments may be combined, falling within the scope of the invention.

### Examples

The invention is further detailed by the accompanying FIGURES, which are exemplary and explanatory of nature and are not limiting the scope of the invention. To the person skilled in the art it may be clear that many variants, being obvious or not, may be conceivable falling within the scope of protection, defined by the present claims.

A prototype facility has been built to reduce a gamma-ray flux and to reduce the radiation damage. It was observed that the solubility of an irradiated Molybdenum containing organic compound reduces by a factor of 6 when compared to irradiation without shielding. The lower the solubility, the lower the radiation damage, hence the damage was reduced significantly.

It has been found that ¹⁶⁶Ho packed in poly(L-lactic acid microspheres is produced at a high specific activity (e.g., >100 GBq/g ¹⁶⁶Ho). This seems not possible without gamma-ray shielding and target cooling.

The present substantial reduction of radiation damage of e.g. Mo-containing organic compounds will boost further development of the production of carrier-free ⁹⁹Mo, separated by recoil from neutron activated ⁹⁸Mo. Such is considered an inexpensive alternative to the production of ⁹⁹Mo by fission of (low enriched) uranium.

Similarly, present invention provides a higher specific activity of ¹⁶⁶Ho in poly-lactic acid containing microspheres, which will widen the use of these compounds in e.g. cancer therapy.

### SUMMARY OF FIGURE

The invention although described in detailed explanatory context may be best understood in conjunction with the accompanying FIGURES.

FIG. 1 shows an example of the present facility.

### DETAILED DESCRIPTION OF THE FIGURE

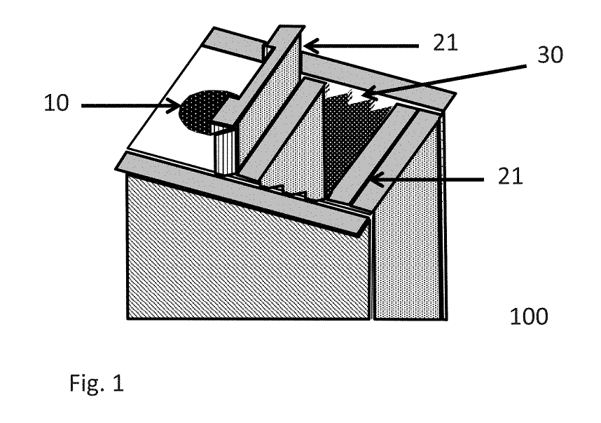

FIG. 1 shows an example of the present facility 100. Therein various sheets 21 are placed in the facility, whereas some empty slots 30 are visible. The sheets can be introduced and removed by making use of the guides. Each sheet may comprise (one or more of) various materials of varying thickness, in order to shield a sample or object to be irradiated. The sample is placed in the opening 10. The whole facility 100 and parts thereof can be moved.

What is claimed is:

1. A moveable irradiation facility for a nuclear reactor comprising:
a holder,
at least one opening for receiving a sample, and
an adaptable filter, wherein the adaptable filter comprises at least one of a band-gap filter, a blocking medium of certain energies, a gamma radiation generator, and combinations thereof, wherein the adaptable filter is for or has at least one of shielding the sample against at least one specific species of neutrons, shielding the sample against at least one species of beta rays, shielding the sample against at least one species of gamma-rays, at least one energy band pass filter for neutrons, at least one energy band pass filter for beta rays, at least one energy band pass filter for gamma rays, and generating of a specific species of gamma-radiation, and
wherein a band pass energy of the filter is selected from the group consisting of 0-0.5 keV, 0.5-5 keV, 10-30 keV, 100-200 keV, 250-500 keV, and 0.6-5 MeV, and combinations thereof, and the species is at least one of beta rays, gamma rays, and neutrons, and combinations thereof.

2. The irradiation facility according to claim 1, wherein the adaptable filter comprises at least one sheet, wherein the at least one sheet are placed behind one another.

3. The irradiation facility according to claim 2, wherein each sheet individually has a thickness, a composition, and an effective thickness, selected for at least one of absorbing at least one specific species of neutrons, absorbing at least one specific species of gamma-rays, absorbing at least one specific species of beta rays, absorbing a pre-determined fraction of said aforementioned specific species, and generating a pre-determined fraction of a specific species of gamma-radiation.

4. The irradiation facility according to claim 1, wherein the filter or at least parts thereof are removable.

5. The irradiation facility according to claim 2, wherein the sheet material is selected from the group consisting of Pb, Cd, Ni, Sc, Fe+Cr, Fe+Al+S, and Si+Ti.

6. The irradiation facility according to claim 1, wherein the filter comprises empty modules, wherein empty modules are filled with an inert material.

7. The irradiation facility according to claim 1, further comprising at least one slot for receiving a shield.

8. The irradiation facility according to claim 1, wherein an aluminium alloy is used for construction and cladding of at least one shield.

9. A method of at least one of removing thermal heat from an irradiated object, adjusting an energy distribution, adjusting a neutron ray intensity, and adjusting a gamma-ray intensity, the method comprising the steps of:
providing a radiation source for emitting radiation, and
shielding an irradiated object with an irradiation facility according to claim 1.

10. The method according to claim 9, wherein at least one of the following occur: thermal neutrons are absorbed, neutrons with a specific energy distribution are absorbed, gamma rays with a specific energy distribution are absorbed, beta rays with a specific energy distribution are absorbed, and gamma-rays with a specific energy distribution are created.

11. The method according to claim 9, wherein excess heat in the object is removed by an external means.

12. The use of an irradiation facility according to claim 1, for one or more of the groups consisting of manipulating an energy distribution of radiation species, absorbing neutrons with an energy of less than 5 eV, generating epithermal and fast neutrons, generating high energy gamma-radiation, and generating low energy gamma-radiation.

13. A product obtained by the method according to claim 9, wherein the product is selected from the group consisting of ¹⁶⁶Ho-isotope comprising organic molecules, ⁹⁹Mo-isotope comprising organic molecules, and ^{177+177m}Lu in an organometallic molecule, and having a specific activity of more than 100 GBq/g isotope.
